(19) United States
(12) Patent Application Publication
(10) Pub. No.: US 2009/0181848 A1
(43) Pub. Date: Jul. 16, 2009

(54) CRYSTALLINE SILICA-FREE DIATOMACEOUS EARTH BLENDED FILTER AIDS AND METHODS OF MANUFACTURING THE SAME

(75) Inventors: Peter E. Lenz, Reno, NV (US); Michael J. Nannini, Sparks, NV (US); James S. Shui, Reno, NV (US)

Correspondence Address: SNELL & WILMER L.L.P. (Main), 400 EAST VAN BUREN, ONE ARIZONA CENTER, PHOENIX, AZ, 85004-2202, US

(73) Assignee: EP MINERALS, LLC, Reno, NV (US)

(21) Appl. No.: 12/408,489

(22) Filed: Mar. 20, 2009

Related U.S. Application Data
(63) Continuation-in-part of application No. 12/167,836, filed on Jul. 3, 2008.
(60) Provisional application No. 60/948,372, filed on Jul. 6, 2007.

(51) Int. Cl. B01J 20/14; B02C 23/08; B02C 23/00

(52) U.S. Cl. 502/412; 241/65; 241/68

(57) ABSTRACT

A method of producing a range of diatomaceous earth blended filter aids having selectable permeabilities and less than about 1 percent by weight total of crystalline silica and less than about 0.1% by weight total of respirable crystalline silica. The method includes milling diatomaceous earth ore to a size range of between about 100 micrometers and about 1400 micrometers; calcining the milled diatomaceous earth in a calciner; milling the calcined diatomaceous earth in an adjustable milling and classification system to produce diatomaceous earth filter aids, and blending the diatomaceous earth with expanded perlite to form a low bulk density and low solubility filter aid.

### CROSS REFERENCE TO RELATED APPLICATIONS

This application is a continuation-in-part of, and claims priority to, U.S. Ser. No. 12/167,836 filed Jul. 3, 2008 and entitled “CRYSTALLINE SILICA-FREE DIATOMACEOUS EARTH FILTER AIDS AND METHODS OF MANUFACTURING THE SAME,” which itself claims the benefit of and priority to U.S. Provisional Patent Application No. 60/948,372, filed Jul. 6, 2007, entitled “CRYSTALLINE SILICA-FREE DIATOMACEOUS EARTH FILTER AIDS AND METHODS OF MANUFACTURING THE SAME,” which applications are hereby incorporated by reference in their entirety for all purposes.

### FIELD OF INVENTION

The present invention relates to diatomaceous earth blended filter aids and methods and systems for producing the same. More specifically, the present invention relates to diatomaceous earth filter aids blended with expanded perlite which result in blended filter aids containing less than about 1 percent by weight total crystalline silica and less than about 0.1 percent by weight of respirable crystalline silica. The filter aids of the present invention may have a permeability ranging from about 0.2 darcy to about 2.5 darcy.

### BACKGROUND OF THE INVENTION

Diatomaceous earth has been used for many years in a number of applications utilizing its absorptive properties and its filtration properties, among other applications. Diatomaceous earth ore is a naturally occurring ore that is fairly easily crushed or crumbled into a fine powder. Diatomaceous earth consists primarily of the skeletal remains of diatoms, which is a type of algae, and includes primarily silica, along with some minor amounts of sodium, aluminum, and iron. The percentages of the various elements may vary depending on the source or collection point of the diatomaceous earth, but generally the silica (in an amorphous form) constitutes over 85% by weight of the diatomaceous earth.

Diatomaceous earth has been used for many years as a filter aid due to its high porosity and because its porosity can be adjusted by modifying the particle size of the final diatomaceous earth product. Conventional processes used to produce diatomaceous earth filter aids typically begin with a crushing and milling step in which the diatomaceous earth ore is milled in an open circuit to a median particle size of between 10 and 20 micrometers. The milled ore is then sent to a calciner where the ore is heated to temperatures greater than about 1000° C. In the past, the calcining step has been done both with and without the addition of a fluxing agent. In conventional processes, the discharge of the calciner is typically refined or milled to attain the desired final particle size prior to packaging.

In conventional processes, some of the amorphous silica (about 1% to about 75%) of the diatom frustules is converted to crystalline silica in the form of cristobalite. This conversion occurs during calcination at high temperature, with or without the addition of a fluxing agent. Crystalline silica is considered to be a health risk by many, especially in a respirable form (i.e., particle size smaller than 10 micrometers). Diatomaceous earth filter aids produced through conventional methods contain greater than 1% by weight of respirable crystalline silica and generally contain 50-75% by weight of crystalline silica. There has been an industry focus on efforts to reduce the amount of crystalline silica in diatomaceous earth filter aids and particularly the amount of respirable particles of crystalline silica. Unfortunately, these efforts heretofore have not been successful at developing an economical method capable of producing filter aids with a diversity of permeabilities.

It is known that the conversion from amorphous silica to crystalline silica occurs at high temperatures, whether flux is added or not, and that the conversion is accelerated when a sodium-based flux is added. Accordingly, efforts to reduce crystalline silica formation have included attempts to calcine without a fluxing agent, to calcine with a non-sodium based flux, to reduce the time the diatomaceous earth is exposed to high heat in the calciner (so called “flash calcining”), to eliminate the calcining step altogether, or some combination of the above. The reason that high temperatures and flux are used during conventional calcining is that without these two factors, high permeability diatomaceous earth filter aids cannot be economically manufactured. High heat by itself causes some sintering of the diatoms in the calciner, drives off water of hydration, reduces the specific surface area, and results in a filter aid with permeabilities of between 0.05 and 1 Darcy. In contrast, diatomaceous earth filter aids that have been processed without calcining (natural grades) have a much more restricted permeability range, typically 0.01 to 0.10 Darcy. When flux is added prior to calcining, a vitreous phase is formed that serves to agglomerate individual diatoms (and fragments thereof) into much coarser particles. Diatomaceous earth filter aids manufactured using a flux have permeabilities of between about 0.4 and 30 Darcy.

To produce diatomaceous earth filter aids having a range of permeabilities (i.e., ranging from 0.01 darcy to greater than 10 darcy, including for example 20 darcy or 30 darcy), a variety of processes would be implemented to produce the various filter aids.

For example, diatomaceous earth filter aids produced without calcining have a restricted permeability range between 0.01 darcy and 0.10 darcy. The addition of heat, such as in a conventional calcining step, causes some sintering of the diatoms, drives off the water of hydration, reduces the specific surface area of the particles, and results in filter aids with permeabilities between 0.05 darcy and 1.0 darcy, but also produces some crystalline silica. In order to obtain still higher permeabilities (i.e., greater than 1.0 darcy), flux is added prior to the calcining step to form a vitreous phase during calcining that agglomerates the individual diatoms and diatom pieces to form much coarser particles. Diatomaceous earth filter aids made using a flux can have permeabilities of between 0.4 darcy and 30 darcy.

Depending on the permeability level desired and the level of crystalline silica tolerable in the final product, conventional diatomaceous earth filter aid manufacturers would run one of the above processes, sometimes being limited in permeability ranges by the tolerable crystalline silica. Accordingly, a single manufacturing process capable of producing a complete range (high and low permeability) of diatomaceous earth filter aids having less than 1% by weight crystalline silica has not been available.

At least two prior attempts to provide such a manufacturing process have been unsuccessful for different reasons. One such attempt was a flash calcine process where the diatomaceous earth was calcined by reducing the residence time of the diatomaceous earth in the hot zone of the calciner. As the formation of crystalline silica is time and temperature dependent, the theory was that by reducing the residence time the formation of cristobalite could be avoided even when a flux was used. However, no one has yet been able to make this concept economically viable on a commercial scale.

Another such attempt included using an alternative fluxing agent, such as substituting a potassium-based flux for the sodium-based flux. While potassium-based fluxing agents have been successfully used to produce diatomaceous earth filter aids, it has not been shown to be able to produce medium or high permeability filter aids.

As such, the present invention provides methods capable of producing diatomaceous earth filter aids having a large range of permeabilities and having less than 1% by weight of crystalline silica and less than 0.1% by weight of respirable crystalline silica. Additionally, the present invention provides diatomaceous earth filter aids having less than 1% by weight of crystalline silica and having permeabilities greater than 1.0 darcy, which were heretofore unattainable.

In various applications, a filter aid having superior density and solubility characteristics is desirable. As such, the present invention further provides an improved low bulk density and low solubility diatomaceous earth blended filter aid that maintains a superior solid/liquid separation capability of conventional calcined and flux-calcined diatomaceous earth filter aids, and does not contain respirable crystalline silica above a level of 0.1% by weight. Moreover, high temperatures and/or flux are not needed for sintering or agglomeration.

### SUMMARY OF THE INVENTION

The present invention is directed to methods of producing diatomaceous earth blended filter aids. The methods include milling diatomaceous earth ore to a size range of between about 100 and about 1400 micrometers, and in some embodiments, between about 100 micrometers and about 500 micrometers and calcining the milled diatomaceous earth in a calciner adapted to provide uniform heating. The calcined diatomaceous earth is then further milled in an adjustable milling and classification system to produce diatomaceous earth filter aids having a selectable particle size distribution. The diatomaceous earth is then blended with expanded perlite to form a filter aid having a crystalline silica content of <1.0% by weight, having a respirable crystalline silica content of <0.1% by weight, and having improved properties, such as density, permeability and solubility. In various embodiments, the diatomaceous earth blend comprises less than about 70 ppm of low soluble metals such as iron.

The resulting diatomaceous earth blended filter aids have selectable permeabilities ranging from about 0.2 darcy to about 2.5 darcy. In some implementations, the methods include classifying the milled diatomaceous earth ore prior to calcining to remove any diatomaceous earth ore smaller than about 100 micrometers. The diatomaceous earth ore smaller than about 100 micrometers may be directed to a conventional diatomaceous earth filter aid process.

The methods may be adapted to limit the production of crystalline silica. For example, the calciner may be adapted to maintain an internal temperature between about 900° C. and about 980° C. The milled diatomaceous earth may be allowed to remain in the hot zone of the calciner for between about 10 minutes and about 60 minutes. The methods of the present invention may configure the calcining step to maintain the milled diatomaceous earth in a hot zone for a time and at a temperature adapted to harden the diatomaceous earth without forming cristobalite.

The present invention is also directed to diatomaceous earth blended filter aids made by one or more of the methods described herein. For example, diatomaceous earth filter aids comprising milled and calcined diatomaceous earth that was milled to a size range of between about 100 micrometers and about 600 micrometers prior to calcining and that was calcined at a temperature between about 900° C. and about 980° C., further milled to a select particle size distribution, and blended with expanded perlite. As another non-limiting example, the present invention is also directed to diatomaceous earth blended filter aids comprising calcined and milled diatomaceous earth comprising less than about 1.0 wt % of total crystalline silica and having a permeability ranging between about 0.2 darcy to greater than about 2.5 darcy.

Other aspects and features of the present invention will become more apparent with reference to the following detailed description and the accompanying figure(s). While the above is a summary of several aspects of the present invention, it is a summary and is not limiting. For example, other features and aspects not described above but described in more detail below are within the scope of the present invention.

### BRIEF DESCRIPTION OF THE DRAWINGS

FIGS. 1A & 1B are schematic flow charts of exemplary embodiments of a method of manufacturing diatomaceous earth filter aids;

FIGS. 2A & 2B are schematic flow charts of exemplary embodiments of a closed-loop method of manufacturing diatomaceous earth filter aids; and

FIG. 3 is a schematic flow chart of an exemplary embodiment of a method of manufacturing filter aids comprising diatomaceous earth and expanded perlite.

### DETAILED DESCRIPTION

The following description is of exemplary embodiments of the invention only, and is not intended to limit the scope, applicability or configuration of the invention in any way. Rather, the following description is intended to provide a convenient illustration for implementing various exemplary embodiments of the invention. The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, many of the steps may be outsourced to or performed by one or more third parties. Furthermore, any reference to singular includes plural embodiments, and any reference to more than one component or step may include a singular embodiment or step.

That said, a substantially crystalline silica-free diatomaceous earth (DE) blended filter aid and a method of making the same are provided. In an exemplary embodiment, a method of making a substantially crystalline silica-free DE blended filter aid includes the steps of: (a) feeding diatomaceous earth ore to an unconventional wet-end process; (b) heat-treating the diatomaceous earth; and (c) treating the diatomaceous earth ore in a finished-end process. In an exemplary embodiment, expanded perlite is produced and blended with the diatomaceous earth ore from the finished-end process.

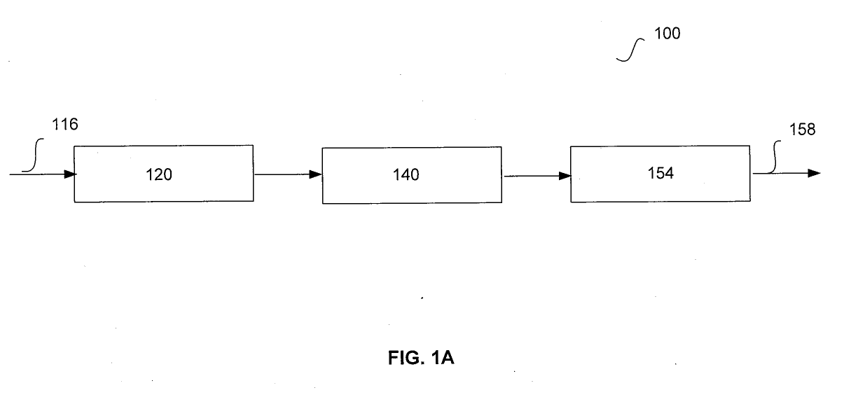

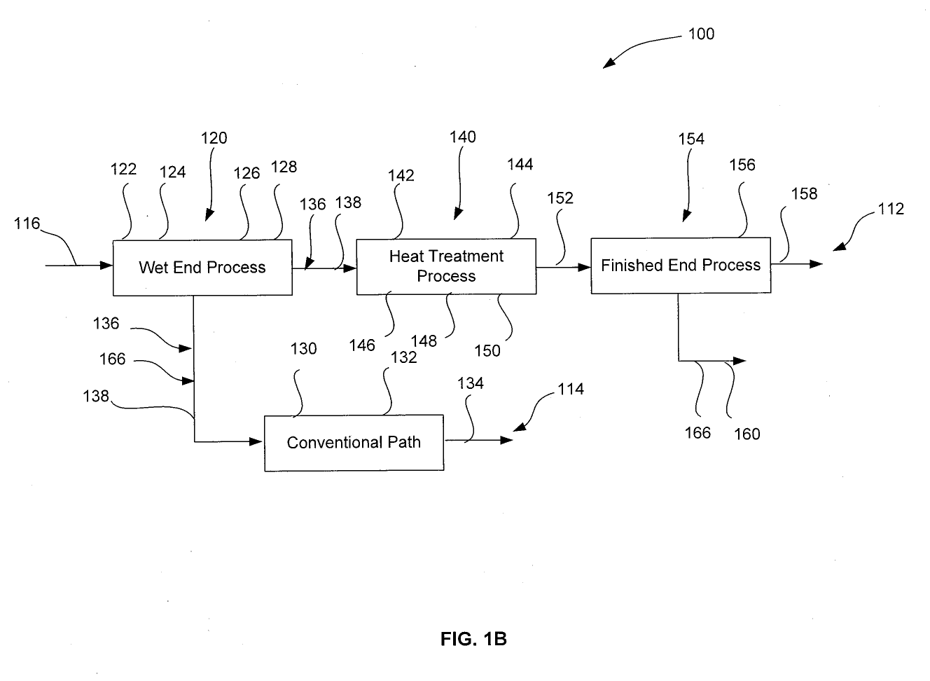

For example, FIG. 1A illustrates schematically a representative method of manufacturing diatomaceous earth blended filter aids according to various embodiments of the present invention. Generally, FIG. 1A illustrates a DE blended filter aid manufacturing process 100, also referred to as the DE process 100, in which diatomaceous earth ore 116 is fed to wet end process 120, heat treated in heat treatment process 140, and further processed in finished end process 154 to produce finished diatomaceous earth blended filter aid 158 having a crystalline silica of less than about 1% by weight.

FIG. 1B illustrates a DE process 100 including a crystalline silica-free path 112 (CS-free path 112) and a conventional path 114. As illustrated and as will be understood from the description below, the conventional path 114 is optional.

With continued reference to FIGS. 1A & 1B, diatomaceous earth ore 116 is fed to a wet end process 120. One or more processes may occur in the wet end process 120, such as crushing processes 122, milling processes 124, drying processes 126, and/or classification processes 128. The diatomaceous earth ore 116 is processed in the wet end process 120 to a particle size range between about 100 micrometers and about 1400 micrometers. In an exemplary embodiment, the diatomaceous earth ore is reduced to a particle size range of about 100 to about 500 micrometers in diameter. In an exemplary embodiment, the diatomaceous earth is reduced to a top size of about 35 mesh (500 micrometers).

Depending on the particle size of the feed ore 116, the wet end process 120 may include at least one crushing apparatus adapted to reduce the diatomaceous earth ore to a size suitable for milling. Additionally or alternatively, the ore 116 may be milled without being crushed in the wet end process 120. The milled diatomaceous earth may pass through a classification process 128 adapted to screen out particles smaller than 100 micrometers and larger than 1400 micrometers. The milled diatomaceous earth may also be dried through a drying process 126. The drying process 26 may occur before, during, or after the classification process.

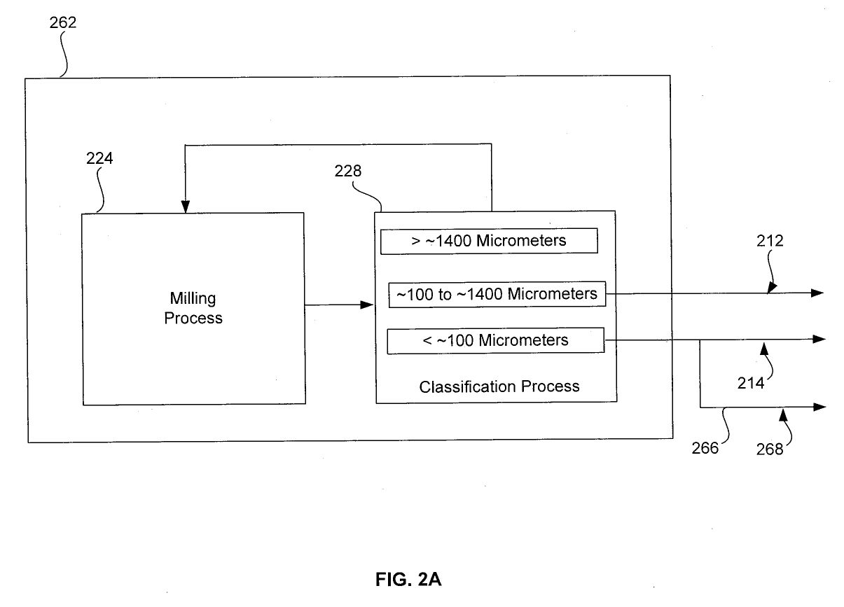

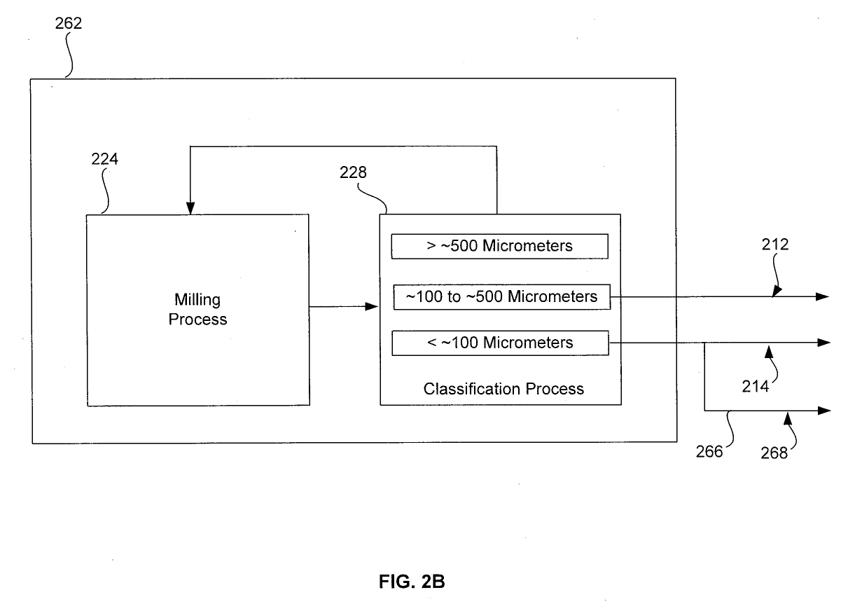

Referring simultaneously to FIG. 1B and FIGS. 2A & 2B, the milling process 124/224 and the classification process 128/228 may be configured in a closed-circuit loop 262 adapted to cycle larger particles (i.e., particles larger than about 1400 micrometers) back to the milling process 224 from the classification process 228 and to allow particles between about 100 micrometers and about 1400 micrometers to pass through to the subsequent processing steps of either the CS-free path 112/212 or the conventional path 114/214. The steps and processes within the wet end process 120 may be ordered or configured in any suitable manner to produce a milled stream 136 of milled diatomaceous earth ore 138 for further processing.

Additionally, and with continued reference to both FIG. 1B and FIGS. 2A & 2B, the wet end process 120 may be configured to remove 166/266 particles of diatomaceous earth that are smaller than 100 micrometers so the smaller particles do not proceed through the CS-free path. The diatomaceous earth particles smaller than about 100 micrometers generated in the wet end process 120 may be directed to a waste stream 268 or may be directed to a conventional diatomaceous earth processing path 114. The conventional diatomaceous earth processing path 114 may include a conventional calciner 130 and any number of other conventional apparatus 132 adapted to produce a conventional diatomaceous earth filter aid 134, such as filter aids containing substantial and/or significant quantities of crystalline silica.

Referring now primarily to FIG. 1B and continuing with the discussion of the CS-free path 112, the milled diatomaceous earth ore 138 is fed from the wet end process 120 to a heat treatment process 140 adapted to calcine the dried and sized diatomaceous earth ore. The heat treatment process 140 may include a calciner 142 adapted for low temperature calcination. The calciner 142 may include any suitable calciner now known or hereinafter developed, including, but not limited to, a directly or indirectly fired rotary kiln or a fluid bed calciner. The calciner 142 selected for use may preferably be adapted to provide uniform heating within the hot zone 144 of the heat treatment process 140. The hot zone 140 of the heat treatment process 140 may include any region and/or period of the heat treatment process, including the calciner 142, where and/or when the diatomaceous earth ore 138 is exposed to elevated temperatures.

The heat treatment process 140 may include a variety of other processes and/or apparatus adapted to support the calcining of the diatomaceous earth ore 138. For example, belts or other transport systems 146 may be included to move the diatomaceous earth ore 138 through the hot zone. Additionally, apparatus adapted to provide the heat and other elements of a suitable calcining environment may be included in the heat treatment process, such as heaters 148 and oxygen supply apparatus 150. The calcining temperature (i.e., the temperature in the hot zone 144) may be maintained below about 1000° C. In some implementations, temperature control elements may be incorporated into the heat treatment process 140 to maintain the calcining temperature below about 980° C. Effective calcining requires the hot zone 144 to be maintained above a minimum temperature, which may be above about 850° C. In some implementations, temperature control elements may be adapted to maintain the calcining temperature between about 900° C. and about 980° C.

Depending on the temperature of the hot zone 144, the size of the diatomaceous earth particles, the oxygen concentration in the hot zone, among other factors, the heat treatment process 140 may be adapted to move the milled diatomaceous earth ore 138 through the hot zone 144 at different rates. For example, the belts or other transport systems 146 configured to move the diatomaceous earth ore 138 through the hot zone at a flow rate of about 100 to about 600 pounds per hour, and in various embodiments at a flow rate of about 300 pounds per hour, so as to provide a hot zone residence time of between about 10 minutes and about 60 minutes. The shorter residence times may be suitable for higher temperature hot zones.

In an exemplary embodiment, other than heat and excess oxygen, no other supplemental elements are applied in the heat treatment process 140. More specifically, no fluxing agent is required by the present DE process 100 to produce diatomaceous earth filter aids having a full range of permeabilities (e.g., including permeabilities of about 0.2 to about 2.5 darcy). In addition to the heat provided in the calciner 142, the heat treatment process 140 may include oxygen supply apparatus 150 adapted to maintain the presence of oxygen (i.e., oxygen beyond what is needed for combustion) in the calciner. The excess oxygen may be at least 8% and, in some embodiments, may be about 20% greater than the total amount of oxygen needed for combustion (where the normal composition of dry air has about 20.95% oxygen.

The heat treatment processes 140 may be conducted at low temperatures compared to the conventional methods of producing DE filter aids. In an exemplary embodiment, the lower temperatures of the heat treatment processes 40 of the present invention serves only to remove water of hydration and low levels of organic content from the milled diatomaceous earth ore 138, to slightly harden the individual particles of diatomaceous earth, and to oxidize any metals, such as iron, that may be present in the ore. Because the milled diatomaceous earth ore 138 fed to the heat treatment process is more coarse than in conventional processes, high temperatures and flux are not needed to sinter or agglomerate the diatomaceous earth particles. Accordingly, the formation of cristobalite is reduced if not eliminated. Conventional diatomaceous earth filter aid processes relied upon the calcination conditions to determine the particle size of the filter aids (i.e., temperatures, flux, and residence times being controlled to produce larger or smaller agglomerated particles) and the resulting permeabilities, which enabled a full range of permeabilities including permeabilities between 10 and 30 darcy. The present systems and methods control permeabilities and particles size distribution by controlling the milling and classification of the diatomaceous earth ore feed 16 and the calcination discharge 152.

The calcination discharge 152 is then treated in a finish end process 154. The finish end process 154 may, for example, include a wet and/or dry process, and may include an adjustable, closed circuit milling and classification system 156. The milling and classification system 156 may include any suitable combination of screens, mechanical classifiers, cyclones, impact mills, media mills, hydrocyclones, filters, etc. adapted to further mill the calcination discharge 152 into a finished diatomaceous earth filter aid 158. The milling and classification system 156 may include one or more adjustable elements to allow the finish end process to produce any desired final particle size distribution to accomplish a full range of permeabilities. For example, the finish end process 154 may be configured to produce diatomaceous earth filter aids having a permeability of about 5 darcy during one period of time, then reconfigured through adjustment of the milling and classification system 156 to produce diatomaceous earth filter aids having a permeability of about 10 darcy during a second period of time. Through control of the wet end process 120 and the finish end process 154, it is possible to develop various filter aids having permeabilities ranging from about 0.01 darcy to about 20 darcy, and in some embodiments, a permeability between about 1.0 to about 10 darcy, and in some embodiments, a permeability between about 0.1 and 0.5 darcy.

The finished end process 154 may also include at least one apparatus adapted to collect and remove fines and trap waste, which may be directed away from the CS-free path 112 via waste stream 160. Depending on the composition of waste stream 160, one or more physical streams may exit the finished end process to separate the materials and/or one or more of the waste streams 160 may undergo further processing and/or separation steps to enable the discharge to be utilized. The removal of baghouse fines may assist in reducing the amount of respirable crystalline silica from the final diatomaceous earth filter aids. For example, it may be desirable for the respirable crystalline silica to be less than about 0.1% by weight of the final diatomaceous earth filter aid composition.

In various embodiments, the diatomaceous earth filter aid is blended with expanded perlite in select ratios, resulting in a range of filter aids with very low crystalline silica content and improved low bulk density, low solubility, and solid/liquid separation efficiencies. Cellulose may also be blended with the diatomaceous earth in place of, or in addition to, the expanded perlite. In various embodiments, the ratio of diatomaceous earth to perlite is about 100:0 to about 20:80. In various embodiments, the ratio of diatomaceous earth to perlite is in the range of about 20:80 to about 80:20.

In various embodiments, the permeability of the perlite is in the range of about 0.1 to about 10 darcy, and in some embodiments, in the range of about 2.5 to about 5.0 darcy.

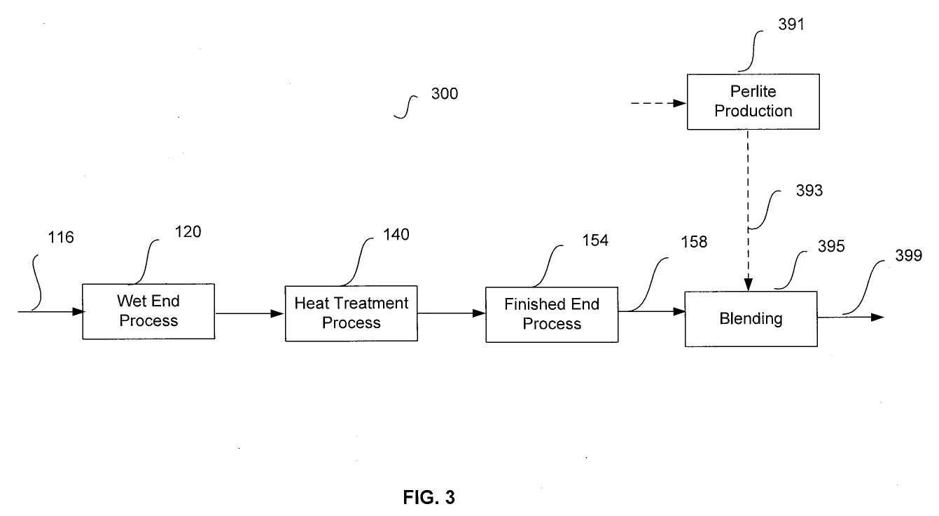

For example, FIG. 3 illustrates a method of producing a diatomaceous earth filter aid 300 that includes the wet end 120, heat treatment 140 and finished end 154 steps discussed above and referenced in FIGS. 1A, 1B, 2A and 2B, and further includes step 395 to blend the finished diatomaceous earth filter aid with expanded perlite. As shown in FIG. 3, finished diatomaceous earth filter aid 158 is combined with expanded perlite 393 to form diatomaceous earth blend filter aid 399. The diatomaceous earth and expanded perlite components may be blended using any suitable blending equipment, such as ribbon blenders and the like. In an exemplary embodiment, the blending equipment is a low-shear, dry product blending device.

In an exemplary embodiment, the diatomaceous earth and expanded perlite components are blended in a ratio suitable to result in the desired density and solubility of the end-product filter aid. In various embodiments, the end-product filter aid comprises less than about 0.1% by weight respirable crystalline silica and less than about 70 ppm of low soluble metals such as iron. In various embodiments, the particle size of the finished diatomaceous earth blend is greater than 40 micrometers, but may be any desired size.

In an embodiment, the ratio of diatomaceous earth to expanded perlite is determined based upon the desired permeability and density of the end product. For example, increased presence of perlite will increase the permeability and decrease the density of the Blended end product. Similarly, an increased presence of diatomaceous earth will decrease permeability and increase the density of the Blended end product.

The perlite may be supplied using any known or hereinafter devised means. In an embodiment, perlite 393 is produced as part of the DE process 300 as step 391. For example, the perlite may be formed using a conventional perlite expander. In other embodiments, the perlite may be supplied by third parties.

In an exemplary embodiment, the diatomaceous earth blended filter aid is produced having end result properties of permeability in the range of about 0.1 to about 10 darcy, and in some embodiments, permeability in the range of about 0.2 to about 2.5 darcy, a crystalline silica content of less than about 1%, and less than about 0.1% by weight of respirable crystalline silica without flash calcination or using flux during calcination and without exceeding a temperature of 1000° C. and with a significant amount of the end product having a particle size diameter of less than about 100 micrometers.

In an exemplary embodiment, calcining is performed at low temperature (relative to normal DE calcining temperatures) so that no cristobalite is formed. The calcination only serves to remove water of hydration and low levels of organic content (purification), slightly harden the individual particles, and to oxidize any metals such as iron that are present in the ore. The expanded perlite component decreases the bulk density and solubility of the end product, while also improving the economics of production.

An exemplary method for preparing a diatomaceous earth blend having perlite to DE ratios of 80:20 and 50:50 is described below in Example 1, which is set for by way of illustration and not by way of limitation.

### EXAMPLE 1

Diatomite ore was blended, crushed to −65 mesh (210 μm), and dried using a flash dry system. The majority of fines (−150 mesh or 105 μm) was removed. The dried, sized ore was then calcined in a direct-fired, pilot rotary kiln at a feed rate of 300 lb/hr, calcining temperature of 960 C., excess oxygen (at kiln rear) level of 14%, and residence time of 30 minutes. The calcined product was conveyed pneumatically to the finish end, milled, and collected from cyclone underflow discharge. A perlite filter aid was then added to make two diatomaceous earth blended filter aids having perlite to DE ratios of 80:20 and 50:50. The DE and perlite components were blended together using a ribbon blender, with blend ratios determined by weight. Data is presented in Table 1 below.

TABLE 1

| Material | DE | Perlite | 80:20 Blend | 50:50 Blend |
|---|---|---|---|---|
| Crystalline | 0.9 | <0.1 | 0.3 | 0.8 |
| Silica (%) | | | | |
| Respirable | <0.1 | <0.1 | <0.1 | <0.1 |
| Crystalline | | | | |
| Silica (%) | | | | |
| Permeability | 0.21 | 2.8 | 1.6 | 0.52 |
| (darcy) | | | | |
| Wet Bulk | 17.5 | 7.0 | 8.0 | 11.5 |
| Density (lb/ft³) | | | | |
| ABK Soluble Fe | 14 | 61 | 51 | 37 |
| (ppm) | | | | |

The foregoing discussion illustrates exemplary methods within the scope of the present invention. Additionally, the foregoing discussion includes exemplary apparatus and systems that may be utilized in implementing the methods of the present invention. Diatomaceous earth blended filter aid processing systems adapted to implement the methods described above, such as those described in connection with the methods described above, are within the scope of the present invention. Similarly, diatomaceous blended aids having less than about 1 percent by weight of crystalline silica and permeabilities of about 0.2 to about 2.5 darcy are within the scope of the present disclosure and invention.

It is believed that the disclosure set forth above encompasses multiple distinct methods, apparatus, and/or compositions with independent utility. While each of these methods and apparatus has been disclosed in its preferred form, the specific embodiments thereof as disclosed and illustrated herein are not to be considered in a limiting sense as numerous variations are possible. The subject matter of the disclosures includes all novel and non-obvious combinations and sub-combinations of the various elements, features, functions and/or properties disclosed herein. The principles of the present disclosure may be embodied in other specific forms without departing from its structures, methods, or other essential characteristics as broadly described herein. The described embodiments are to be considered in all respects only as illustrative, and not restrictive. The scope of the invention is, therefore, not limited by the foregoing description or the following claims, and all changes that come within the meaning and range of equivalency of the foregoing description and/or the following claims are to be embraced within its scope. Similarly, where the description and/or the claims recite “a” or “a first” element or the equivalent thereof, such description should be understood to include incorporation of one or more such elements, neither requiring nor excluding two or more such elements.

It is believed that the following claims are directed to certain combinations and sub-combinations that correspond to disclosed examples and that are believed to be novel and non-obvious. Other combinations and sub-combinations of features, functions, elements and/or properties may be claimed through amendment of the present claims or presentation of new claims in this or a related application. Such amended or new claims, whether they are directed to a different combination or directed to the same combination, whether different, broader, narrower or equal in scope to the original claims, are also regarded as included within the subject matter of the present invention.

1. A filter aid comprising calcined and milled diatomaceous earth and expanded perlite in a ratio of about 100:0 to about 20:80, wherein the filter aid comprises less than about 1 percent by weight total of crystalline silica and having a permeability ranging from about 0.2 darcy to about 2.5 darcy.

2. The filter aid of claim 1, comprising less than about 0.1% by weight of respirable crystalline silica.

3. A method of producing diatomaceous earth blended filter aids, wherein the method comprises:
milling diatomaceous earth ore to a size range of between about 100 micrometers and about 500 micrometers;
calcining the milled diatomaceous earth;
milling the calcined diatomaceous earth in an adjustable milling and classification system to produce finished diatomaceous earth having a selectable particle size distribution; and
blending the finished diatomaceous earth with expanded perlite to form a diatomaceous earth blend filter aid.

4. The method of claim 3, wherein the finished diatomaceous earth and expanded perlite components are present in the filter aid in a ratio of about 100:0 to about 20:80.

5. The method of claim 3, wherein said calcining step utilizes a calciner adapted to maintain a hot zone temperature between about 900° C. and about 980° C.

6. The method of claim 5, wherein the milled diatomaceous earth remains in the hot zone of the calciner for between about 10 minutes and about 60 minutes.

7. The method of claim 5, wherein the calciner is adapted to maintain the milled diatomaceous earth in a hot zone for a time and at a temperature adapted to harden the diatomaceous earth without forming cristobalite or any other form of crystalline silica.

8. The method of claim 3, further comprising the step of directing the diatomaceous earth ore having a particle size less than about 100 micrometers to a conventional diatomaceous earth filter aid process for processing.

9. The method of claim 3, wherein calcining the milled diatomaceous earth is done in the presence of about 8% excess oxygen to about 20% excess oxygen.

10. The method of claim 3, wherein the finished diatomaceous earth and perlite components are blended using a ribbon blender.

11. The method of claim 3, further comprising the step of classifying the milled diatomaceous earth ore to remove any diatomaceous earth ore smaller than about 100 micrometers prior to said calcining step.

12. Diatomaceous earth blended filter aids made by the method of claim 3.

13. Diatomaceous earth blended filter aids comprising milled and calcined diatomaceous earth that was milled to a size range of between about 100 micrometers and about 500 micrometers prior to calcining and that was calcined at a temperature between about 900° C. and about 980° C., and wherein the calcined diatomaceous earth is further milled following calcining to produce diatomaceous earth filter aids having a selectable particle size distribution and blended with expanded perlite, wherein the diatomaceous earth and perlite are present in a ratio of about 100:0 to about 20:80.

14. The diatomaceous earth blended filter aids of claim 13, wherein, the diatomaceous earth blended filter aids have selectable permeabilities between about 0.2 darcy and about 2.5 darcy.

15. A diatomaceous earth blended filter aid processing system comprising:
a first milling and classification system adapted to mill diatomaceous earth ore to produce a milled diatomaceous earth ore having a size range of between about 100 micrometers and about 500 micrometers, the first milling and classification system having a closed-circuit loop;
a calciner adapted to maintain the milled diatomaceous earth ore at a temperature between about 900° C. and about 980° C. for a time selected to limit the formation of crystalline silica, wherein the calciner is adapted to produce calcined diatomaceous earth having less than about 1 percent by weight of crystalline silica;
and about 0.1% by weight of respirable crystalline silica; and
a second finish milling and classification system adapted to receive said calcined diatomaceous earth and to produce diatomaceous earth filter aids; wherein the diatomaceous earth filter aid is blended with perlite to form a diatomaceous earth blended filter aid.

16. The diatomaceous earth blended filter aid processing system of claim 15, wherein the finish milling and classification system includes at least one adjustable element adapted to selectively mill the calcined diatomaceous earth to a desired particle size distribution.

17. The diatomaceous earth blended filter aid processing system of claim 15, wherein the milling and classification loop and the finish milling and classification system are adapted to cooperatively enable production of a range of diatomaceous earth blended filter aids having permeabilities ranging from about 0.2 darcy to about 2.5 darcy.

18. The diatomaceous earth blended filter aid processing system of claim 15, wherein the milling and classification loop includes a classification discharge adapted to remove diatomaceous earth particles smaller than about 100 micrometers.

19. The diatomaceous earth blended filter aid processing system of claim 15, wherein the diatomaceous earth blended filter aid comprises less than about 1% by weight crystalline silica and less than about 0.1% by weight respirable crystalline silica.

20. The diatomaceous earth blended filter aid processing system of claim 15, wherein the particle size range of the diatomaceous earth blended filter aid is in the range of about 100 to about 500 micrometers.

21. A method for producing a diatomaceous earth blended filter aid comprising the steps of:
first creating diatomaceous earth with a permeability in the range of about 0.1 darcy to about 0.5 darcy with a content of less than about 1% by weight of crystalline silica and less than about 0.1% by weight of respirable silica;
blending the diatomaceous earth with expanded perlite having a permeability in the range of about 2.5 darcy to about 5.0 darcy; wherein the diatomaceous earth and the perlite are blended in a ratio of about 100:0 to about 20:80 to achieve an end product having a permeability in the range of greater than about 0.2 to about 2.5 darcy and wherein the diatomaceous earth blended filter aid comprises less than about 1% by weight of crystalline silica and less than about 0.1% by weight of respirable crystalline silica.

22. A method of making a diatomaceous earth blended filter aid having permeability in the range of about 0.2 Darcy to about 2.5 Darcy, a crystalline silica content of less than about 1%, and less than about 0.1% by weight of respirable crystalline silica, comprising the steps of:
first creating diatomaceous earth with a permeability in the range of about 0.1 darcy to about 0.5 darcy with a content of less than about 1% by weight of crystalline silica and less than about 0.1% by weight of respirable crystalline silica;
blending the diatomaceous earth with expanded perlite having a permeability in the range of about 2.5 darcy to about 5.0 darcy; and
wherein the method does not include flash calcination or using flux during calcination.
